(19) United States
(12) Patent Application Publication
(10) Pub. No.: US 2015/0032419 A1
(43) Pub. Date: Jan. 29, 2015

(54) PLC DESIGNING APPARATUS

(71) Applicant: Kenji Tobori, Tokyo (JP)

(72) Inventor: Kenji Tobori, Tokyo (JP)

(73) Assignee: MITSUBISHI ELECTRIC CORPORATION, Chiyoda-ku, Tokyo (JP)

(21) Appl. No.: 13/704,098

(22) PCT Filed: Apr. 4, 2012
(86) PCT No.: PCT/JP2012/059213

§ 371 Date: Dec. 13, 2012

(51) Int. Cl. G06F 17/50

(52) U.S. Cl. CPC G06F 17/5054
USPC 703/1

(57) ABSTRACT

An editor-screen display unit configured to cause a display device to display a list of one or more units applicable to a programmable logic controller, a unit-configuration display unit configured to cause the display device to display a model indicating an arrangement state of the one or more units of the programmable logic controller, a unit-selection/arrangement-input detecting unit configured to detect unit selection operation for selecting a unit in the unit list using an input device and unit arrangement operation for designating a CPU unit on the model by operating the input device in a state in which the unit selection operation is maintained, and a management-CPU-determination processing unit configured to determine a CPU that manages the unit selected by the unit selection operation as a CPU included in the CPU unit designated by the unit arrangement operation, are included.

### FIELD

The present invention relates to a PLC designing apparatus.

### BACKGROUND

A programmable logic controller (PLC) is configured by mounting units having various functions such as a power supply unit and a CPU unit and, when necessary, a communication unit and an I/O (Input/Output) unit on a base unit.

There is an engineering environment in which work for determining which unit is mounted in which slot of the base unit of the PLC can be carried out by mouse operation. In this specification, determining which unit is mounted in which slot of the base unit is referred to as “set a unit configuration” as well.

In some PLC, a plurality of CPU units are mounted on a base unit and caused to operate as a multi CPU (Central Processing unit) configuration. When the PLC is designed, it is necessary to determine by CPUs included in which CPU units respective units are managed and set the management by the CPUs as a parameter.

Patent Literature 1 discloses a technology for associating data groups among apparatuses by superimposing icons one on top of another with drag-and-drop operation.

### CITATION LIST

### Patent Literature

Patent Literature 1: Japanese Patent Application Laid-open No. 2003-316430

### SUMMARY

### Technical Problem

However, in the related art, it is necessary to set a unit configuration with mouse operation and further set parameters with keyboard operation. Therefore, there is a problem in that the PLC cannot be quickly designed.

The invention described in Patent Literature 1 associates data groups among apparatuses connected to a network. In designing the PLC, it is necessary to perform unit configuration setting and parameter setting for a unit added anew. However, information concerning these kinds of setting is not generated until the unit is added to the PLC. Therefore, it is difficult to apply the invention described in Patent Literature 1 for associating data groups among apparatuses already connected to a network to design work for the PLC.

The present invention has been devised in view of the above and it is an object of the present invention to obtain a PLC designing apparatus that can easily perform unit configuration and parameter setting.

### Solution to Problem

To solve the above problems and achieve an object, there is provided a PLC designing apparatus according to the present invention formed on a computer including a pointing device and a display device by the computer executing an editor program and configured to design a programmable logic controller having a multi CPU configuration including a plurality of CPU units, the PLC designing apparatus including: an editor-screen display unit configured to cause the display device to display a list of one or more units applicable to the programmable logic controller; a unit-configuration display unit configured to cause the display device to display a model indicating an arrangement state of the one ore more units of the programmable logic controller; a unit-selection/arrangement-input detecting unit configured to detect unit selection operation for selecting a unit in the unit list using the pointing device and unit arrangement operation for designating a CPU unit on the model by operating the pointing device in a state in which the unit selection operation is maintained; and a management-CPU-determination processing unit configured to determine a CPU unit that manages the unit selected by the unit selection operation as a CPU unit designated by the unit arrangement operation.

### Advantageous Effects of Invention

The PLC designing apparatus according to the present invention has an effect that it is possible to easily perform unit configuration and parameter setting.

### BRIEF DESCRIPTION OF DRAWINGS

FIG. 1 is a diagram of the configuration of a first embodiment of a PLC designing apparatus according to the present invention.

FIG. 2 is a diagram of an example of an editor screen that an editor-screen display unit causes a display device to display.

FIG. 3 is a flowchart for explaining an example of a flow of the operation of the PLC designing apparatus.

FIG. 4 is a diagram of an example of a parameter dialog.

FIG. 5 is a diagram of the configuration of a second embodiment of the PLC designing apparatus according to the present invention.

FIG. 6 is a flowchart for explaining a flow of the operation of the PLC designing apparatus according to the second embodiment.

FIG. 7 is a diagram of an example of unit selection operation and unit arrangement operation.

FIG. 8 is a diagram of the configuration of a third embodiment of the PLC designing apparatus according to the present invention.

FIG. 9 is a flowchart for explaining a flow of the operation of the PLC designing apparatus according to the third embodiment.

FIG. 10 is a diagram of an example of unit selection operation and unit arrangement operation.

FIG. 11 is a diagram of an example of a model displayed in a configuration display region in a PLC designing apparatus according to a fourth embodiment.

### DESCRIPTION OF EMBODIMENTS

Embodiments of a PLC designing apparatus according to the present invention are explained in detail below based on the drawings. The present invention is not limited by the embodiments.

### First Embodiment

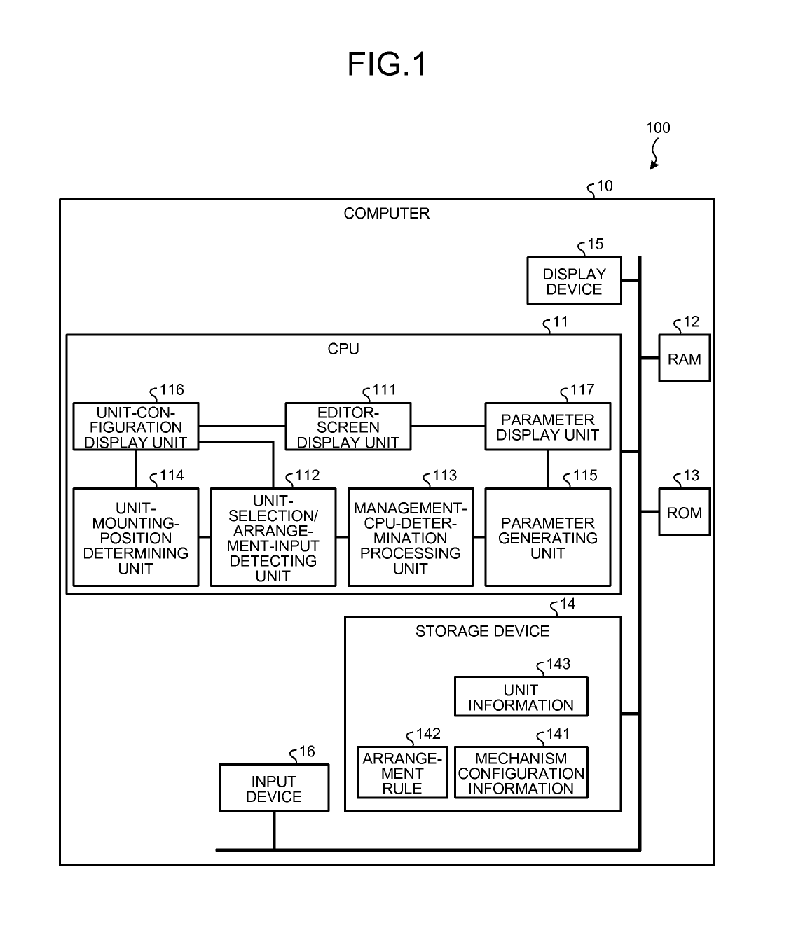

FIG. 1 is a diagram of the configuration of a first embodiment of the PLC designing apparatus according to the present invention. A PLC designing apparatus 100 according to this embodiment is formed by a computer 10 executing an editor program. The computer 10 is a general computer including a CPU 11, a RAM (Random Access Memory) 12, a ROM (Read Only Memory) 13, a storage device 14, a display device 15, and an input device 16.

The CPU 11 reads out the editor program stored in the ROM 13 or the storage device 14 and executes the editor program using the RAM 12 or the storage device 14 as a work area to thereby configure functional units of the PLC designing apparatus 100. The storage device 14 is, for example, a HDD (Hard Disk Drive). The storage device 14 stores mechanism configuration information 141, an arrangement rule 142, and unit information 143. The mechanism configuration information 141 is information concerning the configuration of a PLC. The mechanism configuration information 141 includes information necessary for schematically displaying, on an editor screen, a unit configuration of the PLC such as a type (a total number of slots) of a base unit and the positions of mounted units and free slots. The arrangement rule 142 is a predetermined rule (left justification, right justification, random, etc.) referred to by a unit-mounting-position determining unit 114 in determining amounting positions of units. The unit information 143 is information (presence or absence of CPUs, etc.) of units that can be applied to the PLC. As the display device 15, an LCD (Liquid Crystal Display) can be applied. The input device 16 is a pointing device such as a mouse.

The CPU 11 executes the editor program, whereby an editor-screen display unit 111, a unit-selection/arrangement-input detecting unit 112, a management-CPU-determination processing unit 113, the unit-mounting-position determining unit 114, a parameter generating unit 115, a unit-configuration display unit 116, and a parameter display unit 117 are formed on the CPU 11.

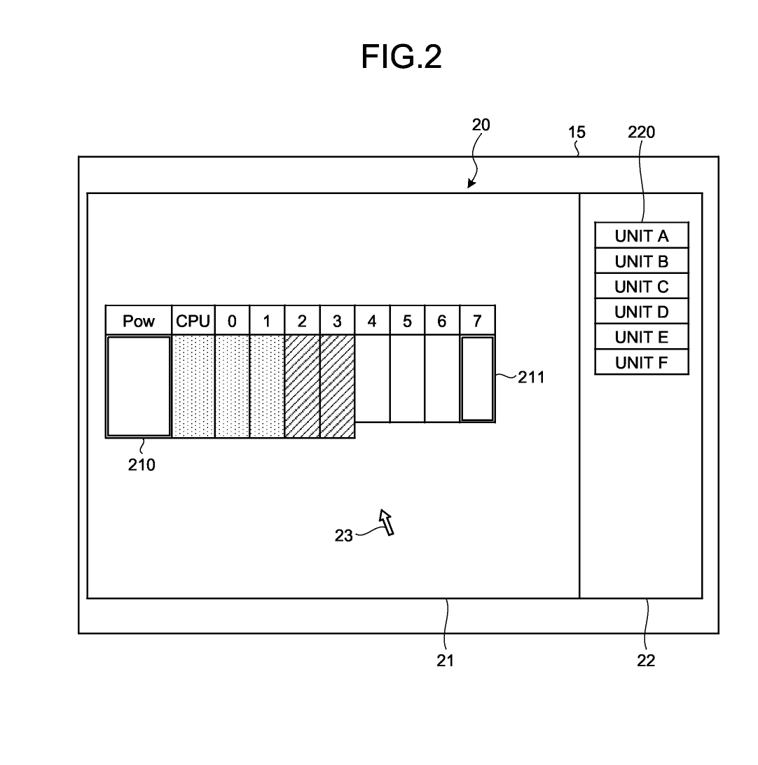

FIG. 2 is a diagram of an example of an editor screen that the editor-screen display unit causes the display device to display. The editor-screen display unit 111 causes the display device 15 to display an editor screen 20 including a configuration display region 21 and a list display region 22 and a pointer (a mouse cursor) 23. In the configuration display region 21, a model 210 indicating the configuration of the PLC is displayed by the unit-configuration display unit 116. The model 210 is explained below. The editor-screen display unit 111 causes, based on the unit information 143 stored in the storage device 14, the display device 15 to display a unit list 220 indicating units applicable to the PLC in the list display region 22. The pointer 23 moves according to operation of the input device 16. The pointer 23 can be moved across the configuration display region 21 and the list display region 22.

The unit-selection/arrangement-input detecting unit 112 detects unit selection and unit arrangement operation performed by a user operating the input device 16. In this embodiment, the unit selection operation is operation for dragging a unit in the unit list 220 displayed in the list display region 22. In this embodiment, the unit arrangement operation is operation for dropping the unit selected by the unit selection operation (the unit dragged on the unit list 220) on a CPU unit of the model 210 displayed in the configuration display region 21.

The management-CPU-determination processing unit 113 determines a CPU of which unit is caused to manage the selected unit. The parameter generating unit 115 generates, based on the determination of the management-CPU-determination processing unit 113, a parameter of the CPU that manages the selected unit. The parameter display unit 117 causes the display device 15 to display the parameter generated by the parameter generating unit 115. The unit-configuration display unit 116 causes the display device 15 to display the model 210 in the configuration display region 21. The model 210 is illustrated such that units mounted in a base unit 211 and free slots can be identified. In FIG. 2, CPU units are mounted in No. 0 and No. 1 slots in addition to a CPU slot. Units other than a CPU unit are mounted in No. 2 and No. 3 slots. No. 4 to No. 7 slots are free slots. The PLC indicated by the model 210 of FIG. 2 has a multi CPU configuration in which three CPUs are present.

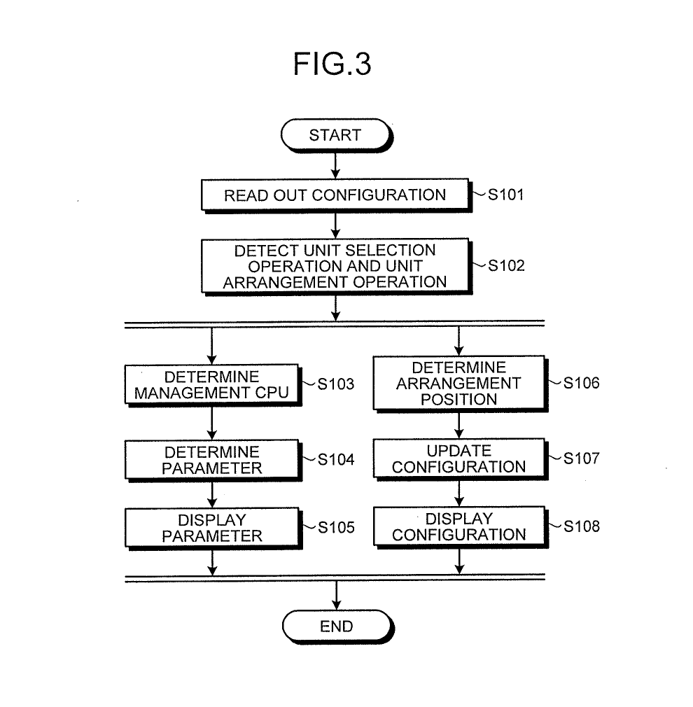

FIG. 3 is a flowchart for explaining an example of a flow of the operation of the PLC designing apparatus. First, the management-CPU-determination processing unit 113 reads out the mechanism configuration information 141 stored in the storage device 14 (step S101). Subsequently, the unit-selection/arrangement-input detecting unit 112 detects that the unit selection operation and the unit arrangement operation are performed on the input device 16 (step S102).

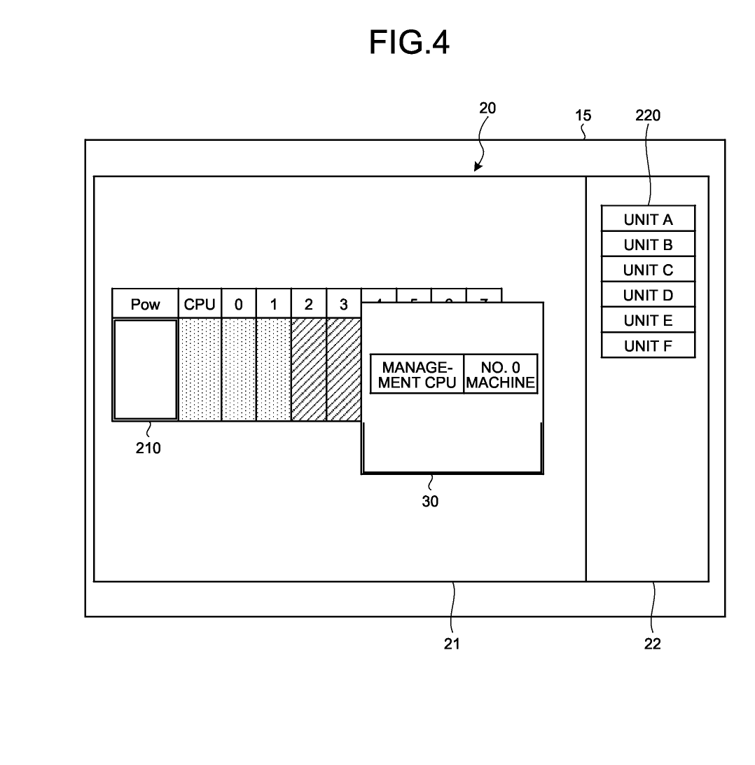

The management-CPU-determination processing unit 113 determines a CPU to be caused to manage a selected unit as a CPU included in a CPU unit for which drop operation is executed (step S103). The parameter generating unit 115 generates a parameter for setting the CPU to be caused to manage the selected unit as the CPU included in the CPU unit on which the selected unit is dropped (step S104). The parameter display unit 117 causes the display device 15 to display a parameter dialog and displays the parameter generated by the parameter generating unit 115 in the parameter dialog (step S105). FIG. 4 is a diagram showing an example of the parameter dialog. The parameter display unit 115 causes the display device 15 to display a parameter dialog 30, whereby, even if a parameter different from an intension is set by wrong operation (management by a CPU different from an intension is set), the user can recognize the error of the setting and manually correct the parameter. Display/non-display of the parameter dialog 30 can be configured to be set by the user. A method of presenting the parameter generated by the parameter generating unit 115 to the user is not limited to the display in the parameter dialog. For example, the parameter generated by the parameter generating unit 115 can be displayed in a child frame or a docking window. The PLC designing apparatus 100 can also be configured to not include the parameter display unit 117.

The unit-mounting-position determining unit 114 determines, according to the mechanism configuration information 141 and the arrangement rule 142 stored in the storage device 14, in which free slot the selected unit is mounted (step S106). The unit-configuration display unit 116 additionally arranges the selected unit in the free slot according to the arrangement rule 142 and updates the mechanism configuration information 141 (step S107). The unit-configuration display unit 116 causes the display device 15 to display the model 210 of a PLC having a configuration in which the unit is additionally arranged (step S108).

The arrangement of the unit in the state shown in FIG. 2 is considered as an example. When the arrangement rule 142 is left justification, a unit C is selected (dragged) out of the unit list 220 displayed in the list display region 22 and dropped on a region of a No. 0 slot of the model 210 displayed in the configuration display region 21. Then, the model 210 in which the unit C is arranged in a No. 4 slot, which is a free slot at the left end, is displayed in the configuration display region 21. Further, a parameter indicating that a CPU included in a CPU unit mounted in the No. 0 slot manages the unit C is set.

As explained above, according to this embodiment, a unit is simply selected out of the unit list and dropped on a CPU unit that the user desires to cause to manage the selected unit, whereby the dropped unit is arranged according to the arrangement rule set in advance and a CPU included in a CPU unit on which the selected unit is dropped is set in a parameter indicating a CPU that manages the unit. Consequently, it is possible to perform the arrangement of the unit and the parameter setting according to a series of operation of drag and drop.

### Second Embodiment

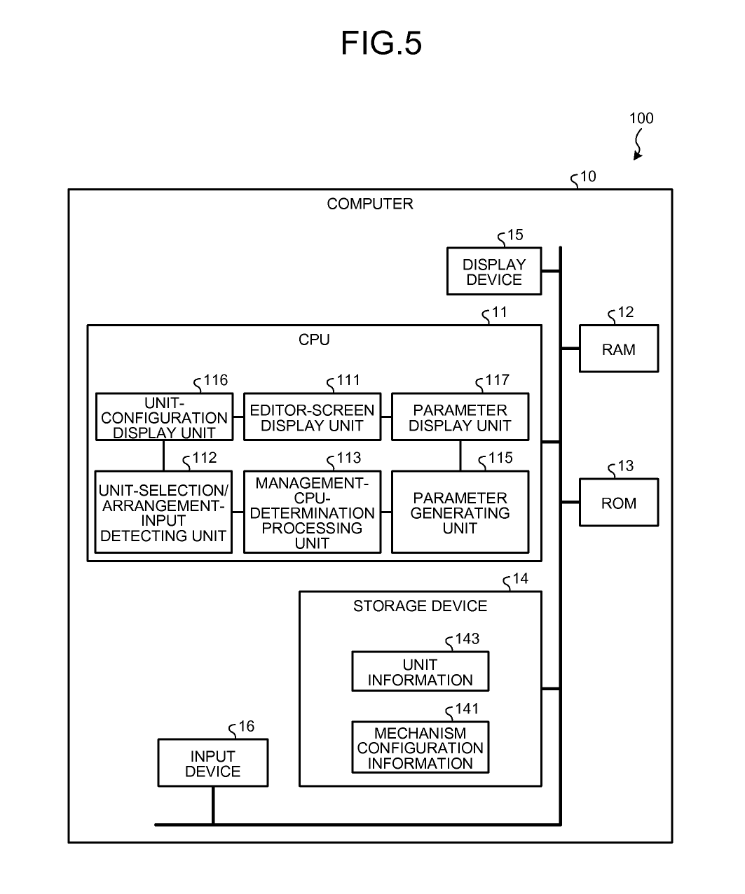

FIG. 5 is a diagram of the configuration of a second embodiment of the PLC designing apparatus according to the present invention. The PLC designing apparatus 100 according to this embodiment is different from the PLC designing apparatus 100 according to the first embodiment in that the PLC designing apparatus 100 does not include a unit-mounting-position determining unit and an arrangement rule is not stored in the storage device 14.

In this embodiment, the unit-selection/arrangement-input detecting unit 112 has a function of detecting, based on the position of the pointer 23, that the pointer 23 comes into contact with a CPU included in the model 210 displayed in the configuration display region 21.

Unit selection operation in this embodiment is the same as the unit selection operation in the first embodiment and is operation for dragging a unit in the unit list 220 displayed in the list display region 22. Unit arrangement operation in this embodiment is operation for dropping a selected unit on a free slot of the model 210 displayed in the configuration display region 21.

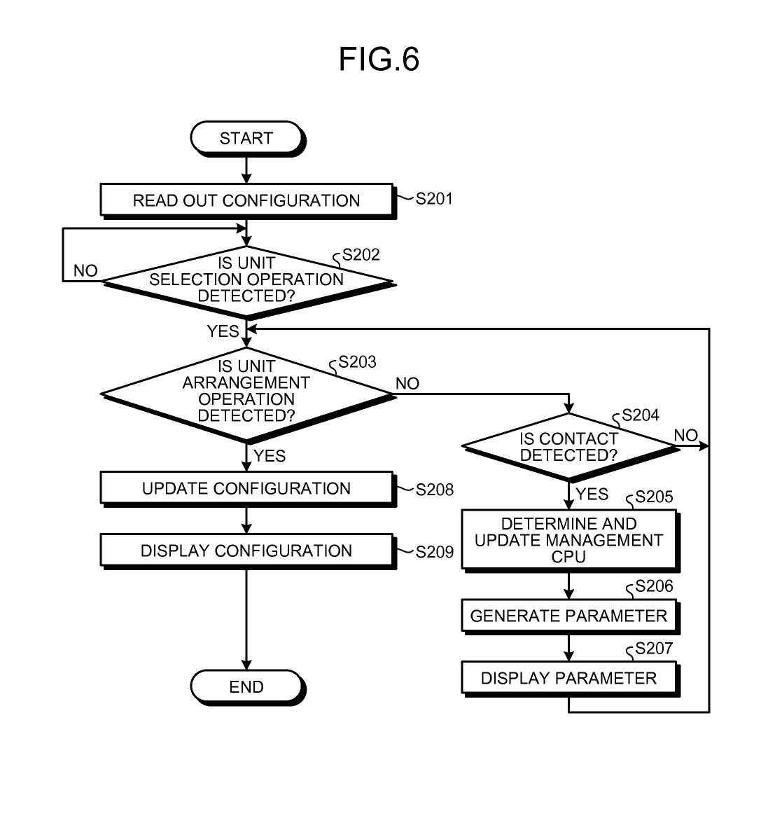

FIG. 6 is a flowchart for explaining a flow of the operation of the PLC designing apparatus according to the second embodiment. First, the management-CPU-determination processing unit 113 reads out the mechanism configuration information 141 stored in the storage device 14 (step S201). Subsequently, the unit-selection/arrangement-input detecting unit 112 monitors whether the unit selection operation is performed (step S202). When the unit-selection/arrangement-input detecting unit 112 does not detect that the unit selection operation is performed (No at step S202), the unit-selection/arrangement-input detecting unit 112 continues to monitor whether the unit selection operation is performed (step S202).

When the unit-selection/arrangement-input detecting unit 112 detects that the unit selection operation is performed (Yes at step S202), the unit-selection/arrangement-input detecting unit 112 monitors whether the unit arrangement operation is performed (step S203). When the unit-selection/arrangement-input detecting unit 112 does not detect that the unit arrangement operation is performed (No at step S203), the unit-selection/arrangement-input detecting unit 112 monitors whether the pointer 23 comes into contact with a CPU unit included in the model 210 displayed in the configuration display region 21 (step S204).

When the pointer 23 comes into contact with the CPU unit included in the model 210 displayed in the configuration display region 21 (Yes at step S204), the management-CPU-determination processing unit 113 determines a CPU to be caused to manage a selected unit as a CPU included in the CPU unit with which the pointer 23 comes into contact (when the CPU is already determined, changes the CPU) (step S205). The parameter generating unit 115 generates a parameter for setting the CPU to be caused to manage the selected unit as the CPU included in the CPU unit with which the pointer 23 comes into contact (step S206). The parameter display unit 117 causes the display device 15 to display the parameter dialog 30 and displays the parameter generated by the parameter generating unit 115 in the parameter dialog 30 (step S207). Thereafter, returning to step S203, the unit-selection/arrangement-input detecting unit 112 monitors whether the unit arrangement operation is performed.

When the unit-selection/arrangement-input detecting unit 112 detects that the unit arrangement operation is performed (Yes at step S203), the unit-configuration display unit 116 additionally arranges the selected unit in a free slot on which the selected unit is dropped and updates the mechanism configuration information 141 (step S208). The unit-configuration display unit 116 causes the display device 15 to display, in the configuration display region 21, the model 210 of a PLC having a configuration in which the unit is additionally arranged (step S209).

When the pointer 23 does not come into contact with the CPU unit included in the model 210 displayed in the configuration display region 21 (No at step S204), returning to step S203, the unit-selection/arrangement-input detecting unit 112 monitors whether the unit arrangement operation is performed.

In the operation explained above, when the unit-selection/arrangement-input detecting unit 112 detects the unit arrangement operation before detecting that the pointer 23 comes into contact with the CPU unit included in the model 210 displayed in the configuration display region 21 (when the unit-selection/arrangement-input detecting unit 112 determines Yes at step S203 without determining Yes at step S204 at all), a CPU to be caused to manage the selected unit is undecided. In this case, as in the past, a managing CPU only has to be designated by separate operation later or a CPU set in advance only has to be determined as the CPU that manages the selected unit. Therefore, concerning a unit for which a managing CPU is undecided but a mounting position of which is determined, it is also possible to arrange the unit according to operation similar to operation for a unit for which a managing CPU is decided.

In the example explained above, the parameter dialog is displayed every time the pointer comes into contact with the CPU unit to enable the user to recognize a CPU included in which CPU unit is determined to manage a parameter. However, the parameter dialog can be displayed in any form as long as the user can recognize that a CPU included in which CPU unit is determined to manage the parameter by the management-CPU-determination processing unit. For example, it is also possible to blink a CPU unit on a model on which the pointer passes last.

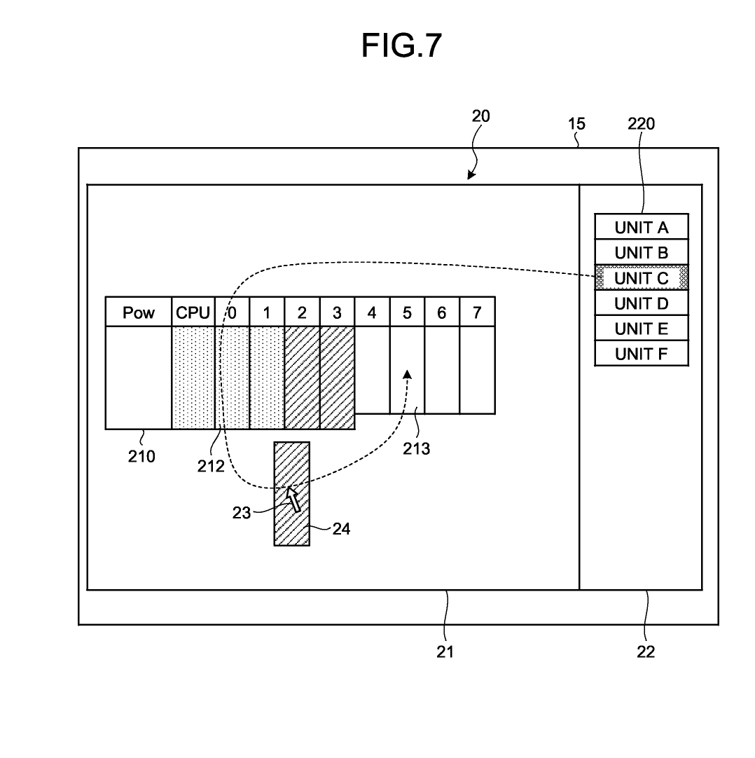

FIG. 7 is a diagram of an example of the unit selection operation and the unit arrangement operation. The unit configuration and parameter setting is completed by a series of operation for dragging a desired unit from the unit list 220 displayed in the list display region 22, operating the input device 16 such that the pointer 23 passes on a CPU unit 212 that the user desires to cause to manage a dragged unit 24, and dropping the unit 24 on a free slot 213 in which the user desires to mount the unit 24.

In this embodiment, the user can arbitrarily select a free slot in which a unit is mounted. Therefore, because it is unnecessary to perform arrangement work in order adapted to the arrangement order of units, it is possible to further improve workability than the first embodiment.

### Third Embodiment

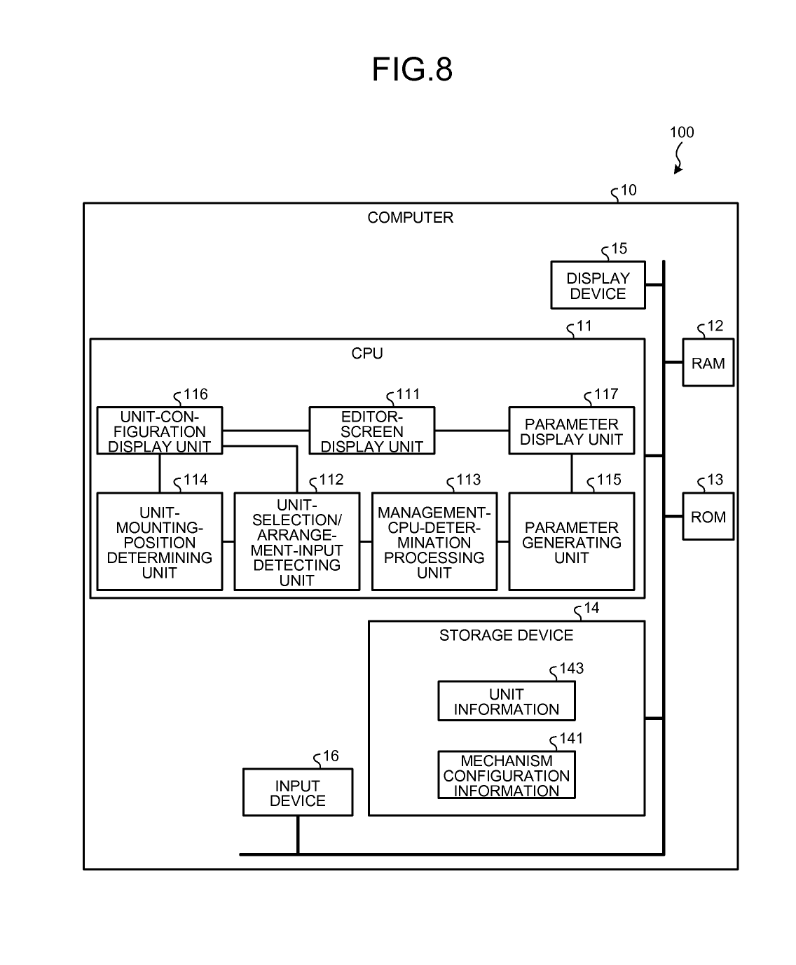

FIG. 8 is a diagram of the configuration of a third embodiment of the PLC designing apparatus according to the present invention. The PLC designing apparatus 100 according to this embodiment is different from the PLC designing apparatus 100 according to the first embodiment in that an arrangement rule is not stored in the storage device 14.

Unit selection operation in this embodiment is the same as the unit selection operation in the first embodiment and is operation for dragging a unit in the unit list 220 displayed in the list display region 22. Unit arrangement operation in this embodiment is operation for bringing a selected unit into contact with a free slot of the model 210 displayed in the configuration display region 21. In the third embodiment, arrangement of the unit and parameter setting are performed by, after dragging a desired unit in a unit list, bringing a pointer into contact with a free slot in which the user desires to mount the unit and dropping the pointer on a CPU that the user desires to cause to manage the unit.

In this embodiment, the unit-selection/arrangement-input detecting unit 112 has a function of detecting, based on the position of the pointer 23, that the pointer 23 comes into contact with a free slot included in the model 210 displayed in the configuration display region 21.

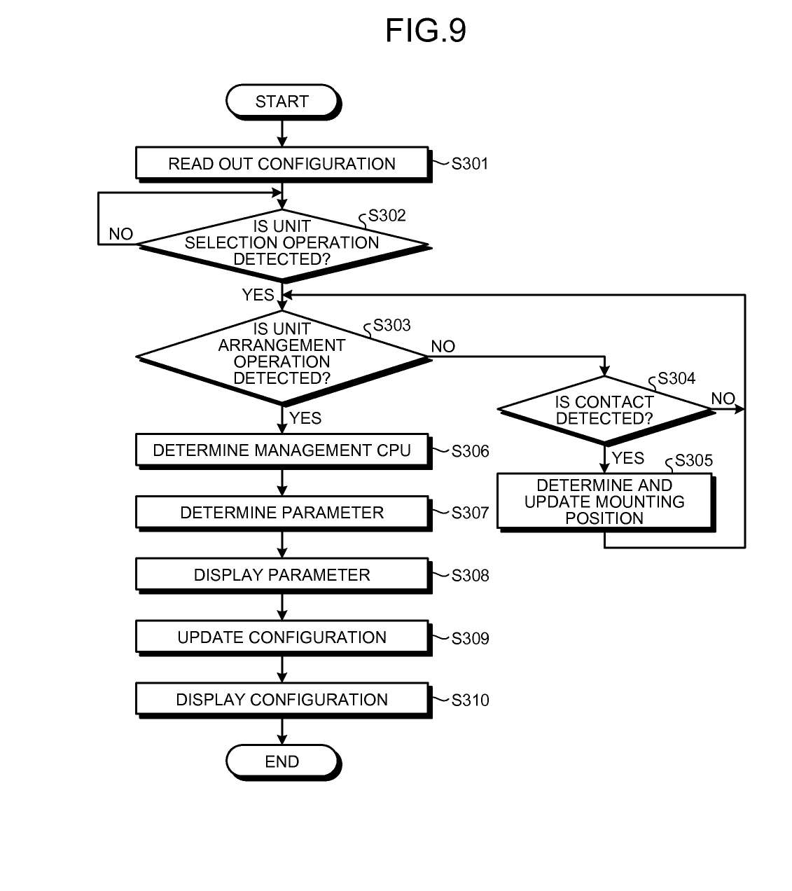

FIG. 9 is a flowchart for explaining a flow of the operation of the PLC designing apparatus according to the third embodiment. The operation at steps S301 and S302 is the same as the operation at steps S201 and S202 in the second embodiment. When the unit-selection/arrangement-input detecting unit 112 detects that unit selection operation is detected (Yes at step S302), the unit-selection/arrangement-input detecting unit 112 monitors whether the unit arrangement operation is performed (step S303).

When the unit-selection/arrangement-input detecting unit 112 does not detect that the unit arrangement operation is performed (No at step S303), the unit-selection/arrangement-input detecting unit 112 monitors whether the pointer 23 comes into contact with a free slot included in the model 210 displayed in the configuration display region 21 (step S304).

When the pointer 23 comes into contact with the free slot included in the model 210 displayed in the configuration display region 21 (Yes at step S304), the unit-mounting-position determining unit 114 determines a mounting position of the unit as the free slot with which the pointer 23 comes into contact (when the mounting position is already determined, updates the mounting position) (step S305). Thereafter, returning to step S303, the unit-selection/arrangement-input detecting unit 112 monitors whether the unit arrangement operation is performed.

When the pointer 23 does not come into contact with the free slot included in the model 210 displayed in the configuration display region 21 (No at step S304), returning to step S303, the unit-selection/arrangement-input detecting unit 112 monitors whether the unit arrangement operation is performed.

When the unit-selection/arrangement-input detecting unit 112 detects that the unit arrangement operation is performed (Yes at step S303), the management-CPU-determination processing unit 113 determines a CPU to be caused to manage the selected unit as a CPU included in a CPU unit on which the selected unit is dropped (step S306). The parameter generating unit 115 generates a parameter for setting the CPU to be caused to manage the selected unit as the CPU included in the CPU unit on which the selected unit is dropped (step S307). The parameter display unit 117 causes the display device 15 to display the parameter dialog 30 and displays the parameter generated by the parameter generating unit 115 in the parameter dialog 30 (step S308).

The unit-configuration display unit 116 additionally arranges the selected unit in the free slot with which the pointer comes into contact and updates the mechanism configuration information 141 (step S309). The unit-configuration display unit 116 causes the display device 15 to display, in the configuration display region 21, the model 210 of a PLC having a configuration in which the unit is additionally arranged (step S310).

In the operation explained above, when the unit-selection/arrangement-input detecting unit 112 detects the unit arrangement operation before detecting that the pointer 23 comes into contact with the free slot included in the model 210 displayed in the configuration display region 21 (when the unit-selection/arrangement-input detecting unit 112 determines Yes at step S303 without determining Yes at step S304 at all), an arrangement position of the selected unit is undecided. In this case, as in the past, update of the mechanism configuration information 141 is not performed at step S309. Therefore, the model 210 of the PLC that the unit-configuration display unit 116 causes the display device 15 to display in the configuration display region 21 is the same as the model 210 before the unit selection operation and the unit arrangement operation are performed. In this case, the user performs separate operation later to designate the arrangement position of the selected unit. Therefore, concerning a unit for which a managing CPU is decided but a mounting position of which is undecided, it is also possible to arrange the unit according to operation similar to operation for a unit for which a mounting position is decided.

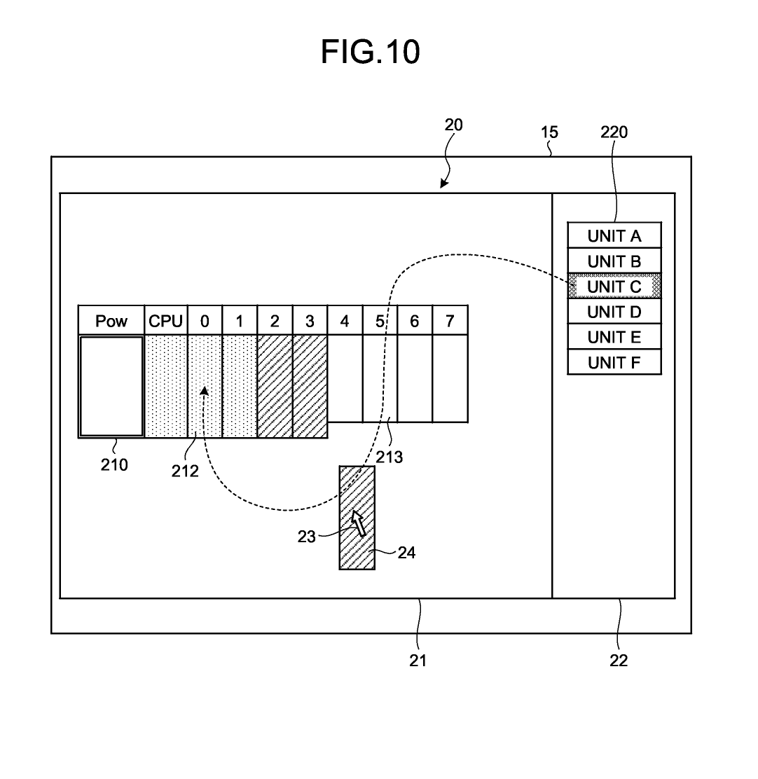

FIG. 10 is a diagram of an example of the unit selection operation and the unit arrangement operation. The unit configuration and parameter setting is completed by a series of operation for dragging a desired unit from the unit list 220 displayed in the list display region 22, operating the input device 16 such that the pointer 23 passes on the free slot 213 in which the user desires to mount the dragged unit 24, and dropping the unit 24 on the CPU unit 212 that the user desires to cause to manage the unit 24.

### Fourth Embodiment

The configuration of the PLC designing apparatus according to a fourth embodiment is the same as the configuration in the second embodiment. However, in this embodiment, the model 210 displayed in the configuration display region 21 by the unit-configuration display unit 116 is different from the model 210 in the second embodiment.

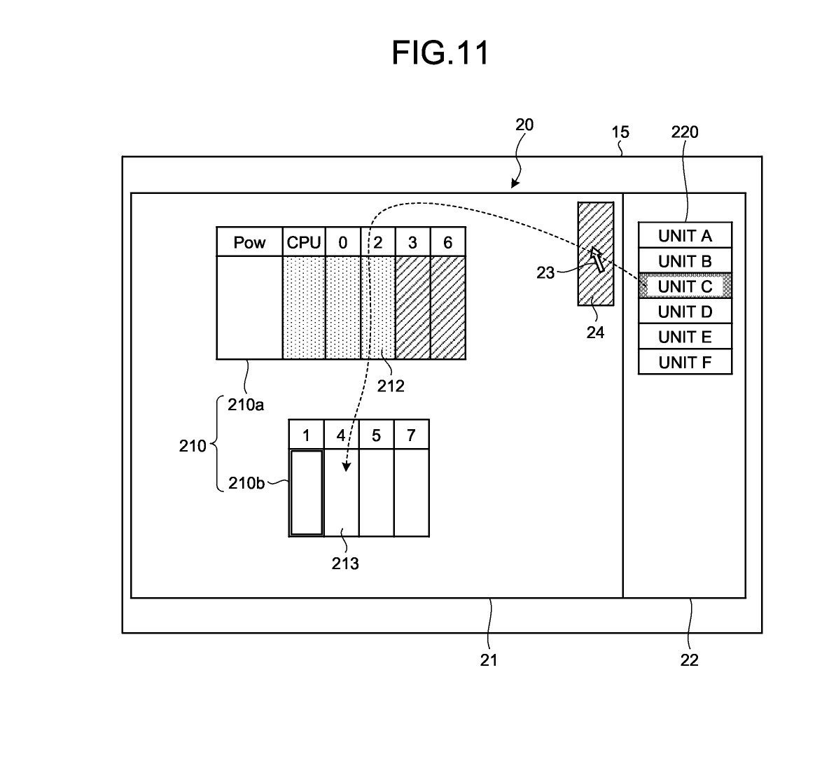

FIG. 11 is a diagram of an example of a model displayed in the configuration display region in the PLC designing apparatus according to the fourth embodiment. The unit-configuration display unit 116 causes the display device 15 to display the model 210 in the configuration display region 21 separately in two stages of a slot 210a in which a CPU unit is mounted and a free slot 210b. Consequently, a moving distance of the pointer 23 in a series of operation for dragging a desired unit from the unit list 220 displayed in the list display region 22, operating the input device 16 such that the pointer 23 passes on the CPU unit 212 that the user desires to cause to manage the dragged unit 24, and dropping the unit 24 on the free slot 213 in which the user desires to mount the unit 24. As a result, workability is improved.

Otherwise, the fourth embodiment is the same as the second embodiment.

In the example explained in the embodiments, the unit selection operation and the unit arrangement operation are the drag & drop operation. However, a pointing device applicable as the input device is not limited to the mouse. For example, when a touch panel is used, it is possible to perform processing same as the processing in the embodiments by replacing the drag with touch operation on the touch panel and replacing the drop with operation for sliding and releasing a finger while touching the touch panel.

### INDUSTRIAL APPLICABILITY

As explained above, the PLC designing apparatus according to the present invention is suitable for design of a PLC having a multi CPU configuration.

### REFERENCE SIGNS LIST

10 computer
11 CPU
12 RAM
13 ROM
14 storage device
15 display device
16 input device
20 editor screen
21 configuration display region
22 list display region
23 pointer
30 parameter dialog
100 PLC designing apparatus
111 editor-screen display unit
112 unit-selection/arrangement-input detecting unit
113 management-CPU-determination processing unit
114 unit-mounting-position determining unit
115 parameter generating unit
116 unit-configuration display unit
117 parameter display unit
141 mechanism configuration information
142 arrangement rule
143 unit information
210 model
211 base unit
220 unit list

1. A PLC designing apparatus formed on a computer including a pointing device and a display device by the computer executing an editor program and configured to design a programmable logic controller having a multi CPU configuration including a plurality of CPU units, the PLC designing apparatus comprising:
an editor-screen display unit configured to cause the display device to display a list of one or more units applicable to the programmable logic controller;
a unit-configuration display unit configured to cause the display device to display a model indicating an arrangement state of the one ore more units of the programmable logic controller;
a unit-selection/arrangement-input detecting unit configured to detect unit selection operation for selecting a unit in the unit list using the pointing device and unit arrangement operation for designating a CPU unit on the model by operating the pointing device in a state in which the unit selection operation is maintained; and
a management-CPU-determination processing unit configured to determine a CPU that manages the unit selected by the unit selection operation as a CPU included in the CPU unit designated by the unit arrangement operation.

2. The PLC designing apparatus according to claim 1, further comprising a unit-mounting-position determining unit configured to determine, according to a rule set in advance, a mounting position of the unit selected by the unit selection operation on the model.

3. The PLC designing apparatus according to claim 1, wherein the unit selected by the unit selection operation is mounted in a free slot in the model with which a pointer comes into contact during the unit arrangement operation.

4. A PLC designing apparatus formed on a computer including a pointing device and a display device by the computer executing an editor program and configured to design a programmable logic controller having a multi CPU configuration including a plurality of CPU units, the PLC designing apparatus comprising:
an editor-screen display unit configured to cause the display device to display a list of one or more units applicable to the programmable logic controller;
a unit-configuration display unit configured to cause the display device to display a model indicating an arrangement state of the one or more units of the programmable logic controller;
a unit-selection/arrangement-input detecting unit configured to detect unit selection operation for selecting a unit in the unit list using the pointing device and unit arrangement operation for designating a mounting position of the unit, which is selected by the unit selection operation, by operating the pointing device in a state in which the unit selection operation is maintained; and
a management-CPU-determination processing unit configured to determine a CPU that manages the unit selected by the unit selection operation as a CPU included in a CPU unit in the model with which a pointer comes into contact during the unit arrangement operation.
